(19) United States
(12) Patent Application Publication
(10) Pub. No.: US 2015/0021353 A1
(43) Pub. Date: Jan. 22, 2015

(54) DISPENSING DEVICE IN VENDING MACHINE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YUN-LUNG CHEN, New Taipei (TW); GANG SU, Wuhan (CN); WEI-YONG MA, Wuhan (CN); CHUAN LIN, Wuhan (CN); JIANG-FENG JIAO, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/260,830

(22) Filed: Apr. 24, 2014

(30) Foreign Application Priority Data
Jul. 18, 2013 (CN) 2013103014389

(51) Int. Cl. G07F 11/42

(52) U.S. Cl. CPC G07F 11/42
USPC 221/277

(57) ABSTRACT

A dispensing device in a vending machine to prevent an accidental loss of goods when being operated by a customer includes a bracket, a shaft, a first mounting member, a second mounting member, and a sleeve. The first mounting member includes two first sidewalls. The second mounting member includes two second sidewalls. The sleeve is secured around the shaft. Each first sidewall and each second sidewall cooperatively define an installation opening rotatably receiving the shaft therein. The sleeve is limited between the first sidewalls and the second sidewalls, preventing the shaft from moving up and down.

### FIELD

The present disclosure relates to vending machines, and particularly to a dispensing device in vending machines.

### BACKGROUND

A direct type dispensing device for dispensing products from vending machines may include a bracket, a tray, and a shaft. The bracket often includes a base for placing the products thereon. The tray is located under the base. The tray is secured to the shaft. The shaft is rotatable under an action of a motor to rotate the tray, to release the base from a position where the base is held and supported. When the tray supports the base, the products are blocked by the base and cannot drop down for the customer. When the tray releases the base, the base is free, causing one product to drop down to the customer bin by gravity.

### BRIEF DESCRIPTION OF THE DRAWINGS

Many aspects of the embodiments herein can be better understood with reference to the following drawings. The components in the drawings are not necessarily drawn to scale, the emphasis instead being placed upon clearly illustrating the principles of the embodiments. In the drawings, like reference numerals designate corresponding parts throughout the several views.

FIG. 1 is an exploded, isometric view of one embodiment of a dispensing device of a vending machine.

FIG. 2 is an enlarged view of circled portion II of FIG. 1.

FIG. 3 is an exploded, isometric view of a second mounting plate, a second mounting member, and a blocking member of the dispensing device of FIG. 1.

FIG. 4 is an exploded, isometric view of a first mounting plate, a first mounting member, and another blocking member of the dispensing device of FIG. 1.

FIG. 5 is an isometric view of the first mounting member of the dispensing device of FIG. 4.

FIG. 6 is an assembled, isometric view of the dispensing device of FIG. 1, with a pushing member in an initial position.

FIG. 7 is an enlarged view of circled portion VII of FIG. 6.

FIG. 8 is similar to FIG. 6, but showing the pushing member in an operating position.

FIG. 9 is a cross sectional view of FIG. 8, taken along line IX-IX.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

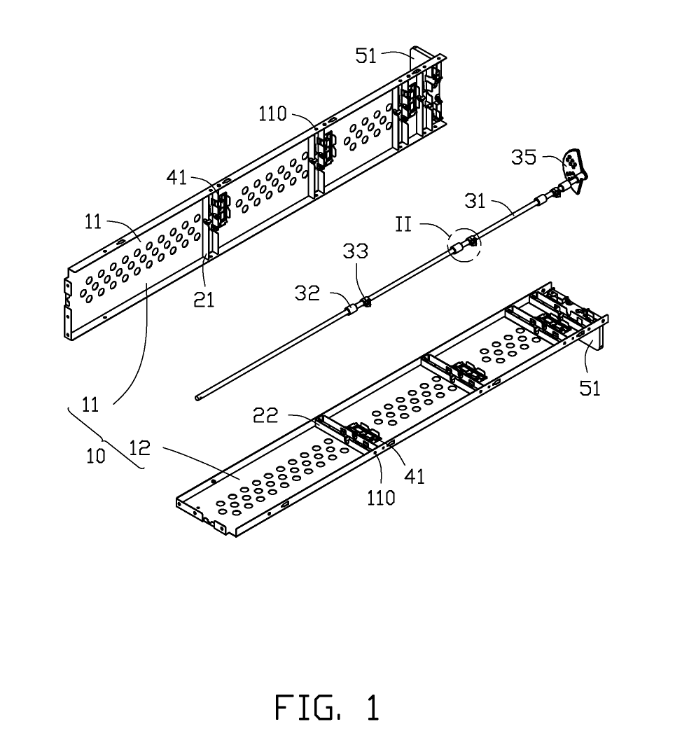

FIG. 1 shows one embodiment of a dispensing device in a vending machine. The dispensing device includes a bracket 10, a shaft 31, a tray 35, a plurality of pairs of mounting members, and a plurality of blocking members 40. The bracket 10 comprises a first mounting plate 11 and a second mounting plate 12 opposite to the first mounting plate 11. A pair of bases 51 is pivotably mounted to the first mounting plate 11 and the second mounting plate 12.

Each pair of mounting members includes a first mounting member 21 secured to the first mounting plate 11 and a second mounting member 22 secured to the second mounting plate 12. The tray 35 is mounted to a distal end of the shaft 31. In one embodiment, the tray 35 is a section of a circle with an interior angle smaller than 180 degrees, that is, smaller than a full semicircle.

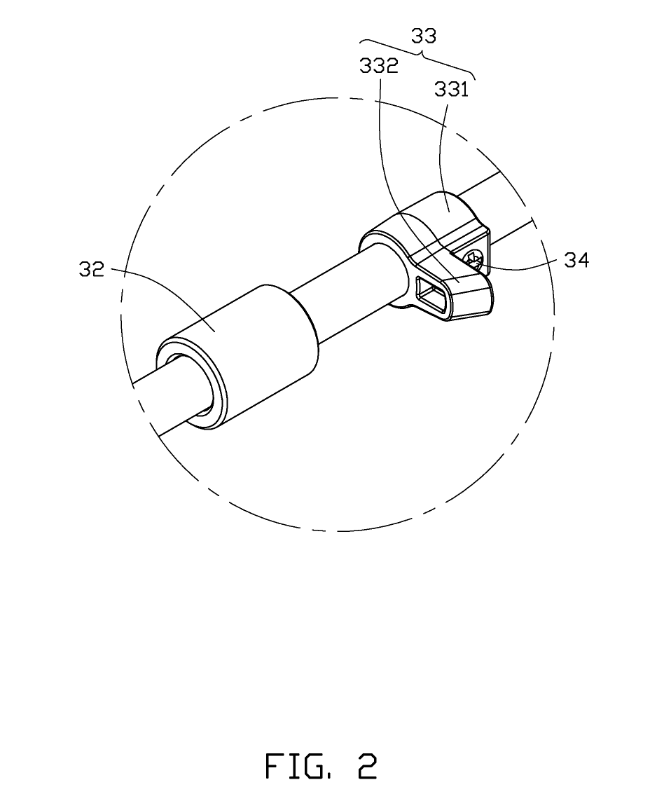

FIG. 1 and FIG. 2 illustrate a plurality of jacking members 33 mounted on the shaft 31. Each jacking member 33 includes a mounting portion 331 secured to the shaft 31 and a jacking portion extending from the mounting portion along a direction substantially perpendicular to an axial direction of the shaft 31. A plurality of sleeves 32 is secured around the shaft 31. In at least one embodiment, the sleeves 32 are made of plastic.

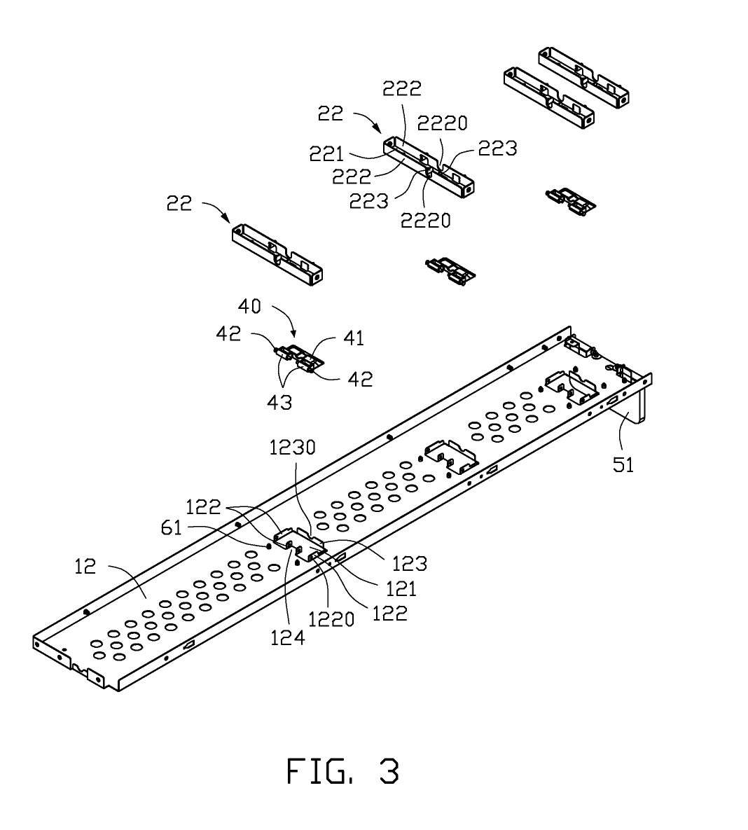

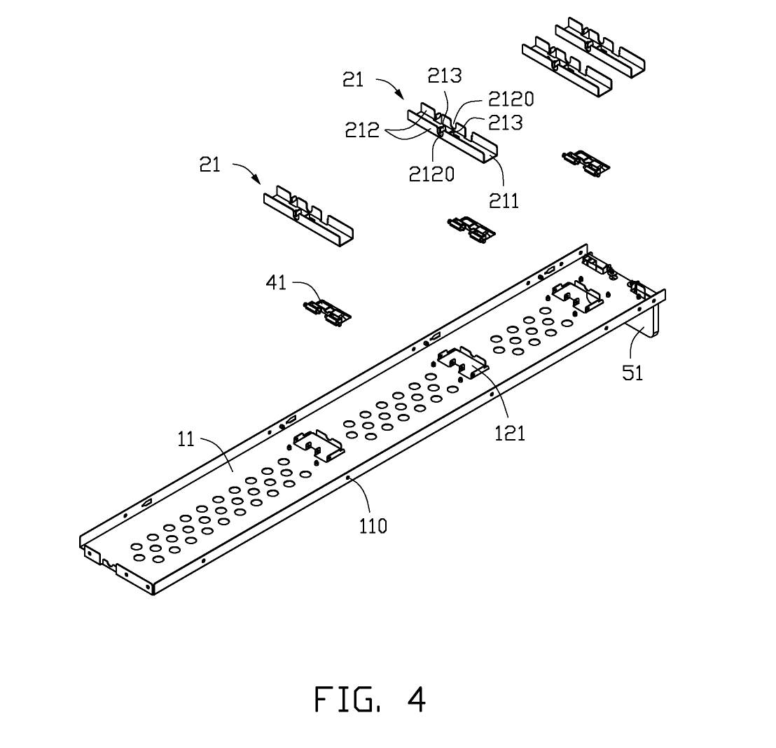

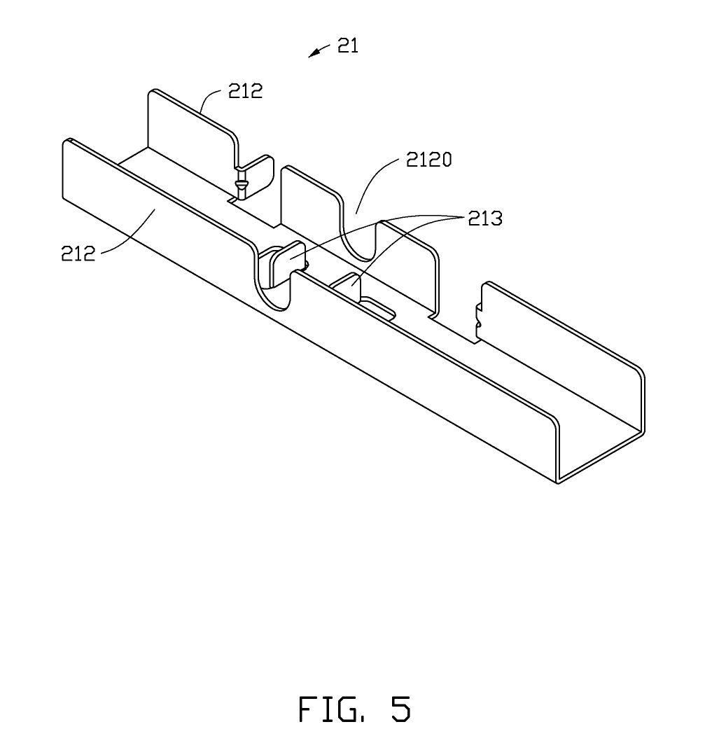

FIGS. 3-5 illustrate each first mounting member 21 including a first bottom wall 211 and two first sidewalls 212 perpendicularly extending from opposite edges of the first bottom wall 211. A pair of first positioning pieces 213 perpendicularly extends from the first bottom wall 211. Each first positioning piece 213 is located between the two first sidewalls 212 and is substantially perpendicular to each first sidewall 212. A distance between the first positioning pieces 213 is substantially equal to an outer diameter of each sleeve 32. Each first sidewall 212 defines a first cutout 2120. In at least one embodiment, the first cutout 2120 is semicircular. A diameter of the first cutout 2120 is smaller than the distance between the first positioning pieces 213. The first cutout 2120 is aligned between the first positioning pieces 213. A length of each first sidewall 212 is substantially equal to a width of the first mounting plate 11.

Each second mounting member 22 comprises a second bottom wall 221 and two second sidewalls 222 perpendicularly extending from opposite edges of the second bottom wall 221. A pair of second positioning pieces 223 perpendicularly extends from the second bottom wall 221. Each second positioning piece 223 is located between the two second sidewalls 222 and is substantially perpendicular to each second sidewall 222. A distance between the second positioning pieces 223 is substantially equal to an outer diameter of each sleeve 32. Each second sidewall 222 defines a second cutout 2220. In one embodiment, the second cutout 2220 is semicircular. A diameter of the second cutout 2220 is smaller than the distance between the second positioning pieces 223. The second cutout 2220 is aligned between the second positioning pieces 223. A length of each second sidewall 222 is substantially equal to a width of the second mounting plate 11.

Each blocking member 40 includes a blocking plate 41, two pivoting portions 43 extending from the blocking plate 41, and a pivoting post 42 extending from each pivoting portion 43. Each of the first mounting plate 11 and the second mounting plate 12 defines a plurality of receiving holes 121 corresponding to the blocking members 40. Two pairs of pivoting pieces 122 extend from edges of each receiving hole 121. Each pivoting piece 122 defines a pivoting hole 1220. A gap 124 is defined between the two pairs of pivoting pieces 122. A width of the gap 124 is substantially equal to the diameter of the shaft 30. A positioning piece 123 extends from a bottom edge of each receiving hole 121. The positioning piece 123 defines a positioning opening 1230 aligned with the gap 124.

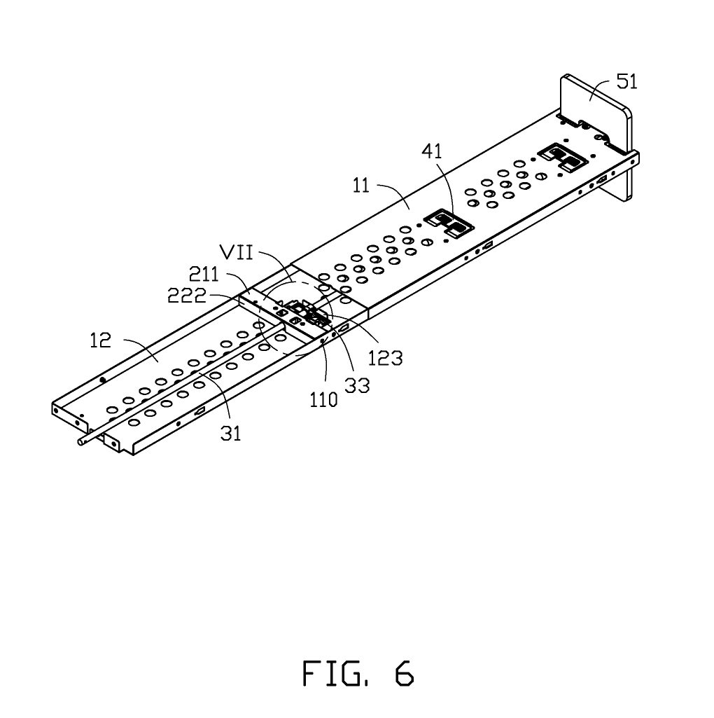

FIGS. 1-7 illustrate that in assembly the blocking member 41 is placed in the receiving hole 121 with the pivoting posts 42 pivotably mounted in the pivoting holes 1220. The blocking member 41 is rotatable relative to the first mounting plate 11 about the pivoting posts 42. The first mounting member 21 is secured to the first mounting plate 11 by screws or other method. The second mounting member 22, aligned with the first mounting member 21, is secured to the second mounting plate 12. In this position, the first cutout 2120 is aligned with the gap 124 and the positioning opening 1230 in the first mounting plate 11, and the second cutout 2220 is aligned with the gap 124 and the positioning opening 1230 in the second mounting plate 12.

A fastener 34 is inserted into the shaft 31 through the mounting portion 331 to secure the jacking member 33 to the shaft 31. The sleeves 32 and the jacking members 33 are staggered on the shaft 31.

The shaft 31 is placed on the second mounting plate 12 in the second cutouts 2220, the gaps 124, and the positioning openings 1230. Each sleeve 32 is located between the pair of positioning pieces 223. The jacking member 33 is aligned with the blocking plate 41. The second mounting plate 12 is secured to the first mounting plate 11 by screws or other method. The first cutout 2120 latches with the second cutout 2220 to form a circular installation opening. The first pair of the positioning pieces 213 and the second pair of positioning pieces 223 engage the sleeve 32 therebetween. The sleeves 32 are further limited between the two first sidewalls 212 or by the second sidewalls 222. The positioning openings 1230 opposite to each other are latched together to form a circular loop to engage the shaft 31. The shaft 31 is connected to a motor (not shown), which rotates the shaft 30. The tray 35 is located under the pair of bases 51 and is rotatable together with the shaft 31. The shaft 31 is substantially perpendicular to a line connecting the two pivoting posts 42 of each blocking member 40.

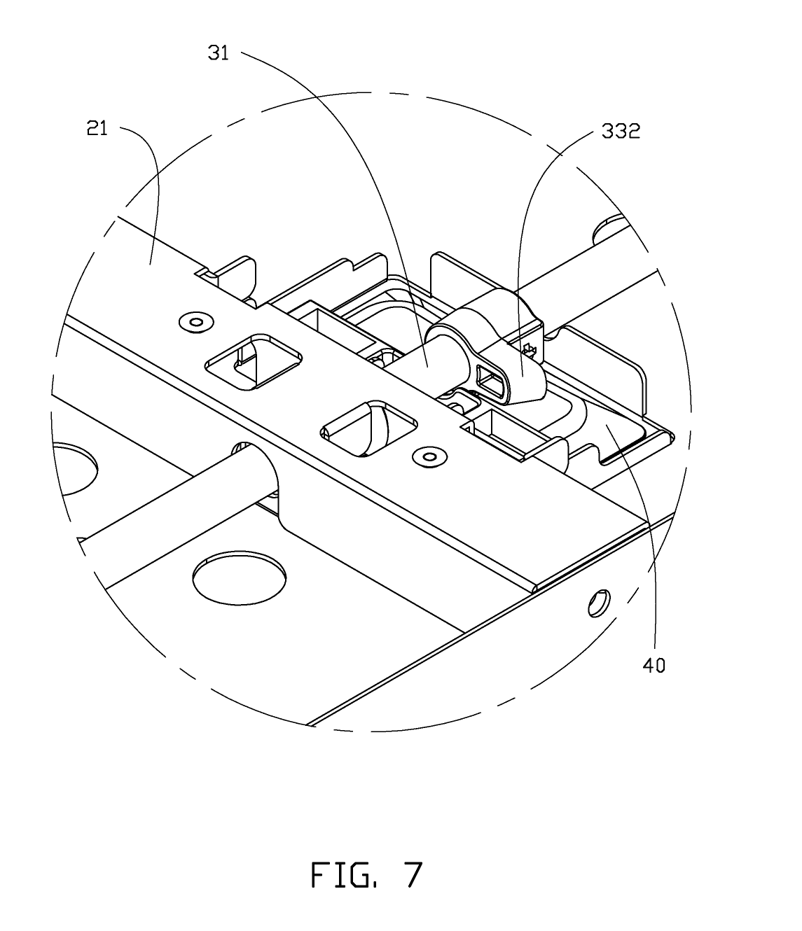

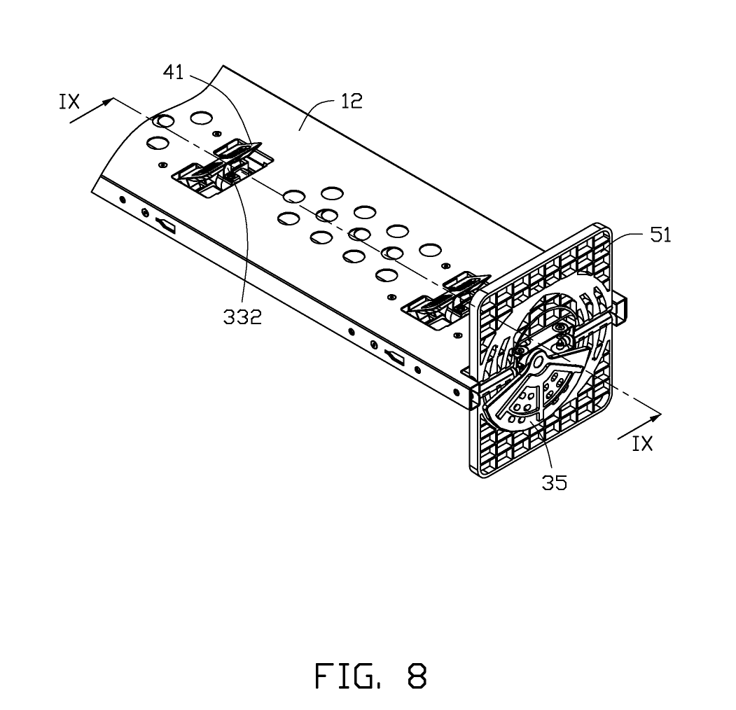

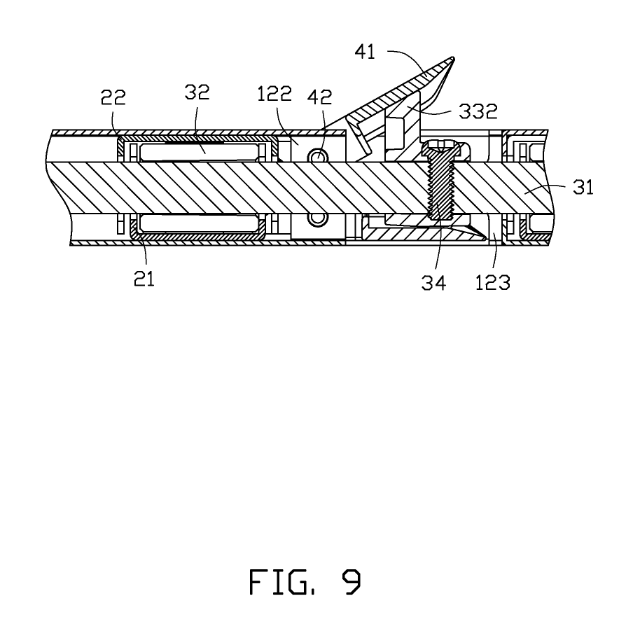

FIGS. 7-9 illustrate that, in use, a plurality of products (not shown) is placed one-by-one on the bases 51. The shaft 31 is rotatable between an initial position and an operating position. The shaft 31 is further rotatable between the initial position and a second position. When the shaft 31 is in the initial position, the jacking members 40 is between the first mounting plate 11 and the second mounting plate 12, the blocking plate 41 is received in the receiving hole 121, and the tray 35 holds the bases 51, preventing the bases 51 from rotating relative to the first mounting plate 11 and a second mounting plate 12. Thus, before a purchase is made, a product cannot be dropped down from each pair of bases 51.

When the shaft 31 is in the operating position, the tray 35 is rotated over one of the pair of bases 51. At the same time, the jacking member 33 extends out of the receiving hole 121 and jacks up the blocking plate 41 from the receiving hole 121. In this position, the products on the other base 51 are rotatable relative to the shaft 31 under the action of gravity and may drop down to the other base 51 if a product is purchased. The blocking plate 41 extends out of the receiving hole 121 to hold and keep the unpurchased products on the other base 51.

When the products 100 are in place but unpurchased, the shaft 31 is in the initial position. When one of the products is purchased, the motor drives the shaft 31 to rotate to the operating position, allowing one product item to drop down from one of the pair of bases 51. Then the motor drives the shaft 31 to rotate to the initial position, causing the tray 35 to rotate one of the pair of bases 51 upwards, until the tray 35 holds the pair of bases 51. The unpurchased products remain in place and are thus prevented from dropping down.

It is to be understood, however, that even though numerous characteristics and advantages have been set forth in the foregoing description of embodiments, together with details of the structures and functions of the embodiments, the disclosure is illustrative only and changes may be made in detail, including in the matters of shape, size, and the arrangement of parts within the principles of the disclosure. The embodiments described herein are illustrative and should not be construes to limit the scope of the following claims.

What is claimed is:

1. A dispensing device in a vending machine, comprising:
a bracket;
a shaft rotatably received in the bracket;
a first mounting member secured in the bracket and comprising two first sidewalls;
a second mounting member secured in the bracket and comprising two second sidewalls; and
a sleeve secured around the shaft;
wherein each first sidewall and each second sidewall cooperatively define an installation opening rotatably receiving the shaft therein; and the sleeve is secured between the two first sidewalls and further secured between the two second sidewalls, and a diameter of the sleeve is greater a diameter of the installation opening, preventing the shaft from moving in an axial direction.

2. The dispensing device of claim 1, wherein a distance between the two first sidewalls is substantially equal than a distance between the two second sidewalls, and a height of the sleeve is smaller than the distance between the two first sidewalls

3. The dispensing device of claim 1, further comprising a base rotatably mounted to the bracket and a tray secured to the shaft and holding the base.

4. The dispensing device of claim 3, wherein the shaft is rotatable relative to the bracket, and when the shaft is rotated relative to the bracket, the tray is released and rotatable relative to the bracket, allowing a product to drop down from the base due to gravity.

5. The dispensing device of claim 1, wherein each first sidewall defines a first cutout, each second sidewall defines a second cutout, the first cutout and the second cutout cooperatively form the installation opening, and each of the first cutout and the second cutout is semicircular.

6. The dispensing device of claim 1, wherein the first mounting member further comprises a first bottom wall connected to the first sidewalls and two first positioning pieces perpendicularly extending from the first bottom wall, the sleeve is located between the two first positioning pieces; the second mounting member further comprises a second bottom wall connected to the second sidewalls and two second positioning pieces perpendicularly extending from the second bottom wall, and the sleeve is located between the two second positioning pieces; and the diameter of the sleeve is smaller than a distance between the two first positioning pieces and smaller than a distance between the two second positioning pieces.

7. The dispensing device of claim 6, wherein each first positioning piece is substantially perpendicular to the first sidewalls, each first sidewall is substantially coplanar with a corresponding second sidewall, and each second positioning piece is substantially perpendicular to the second sidewalls.

8. The dispensing device of claim 3, further comprising a blocking member rotatably mounted to the bracket and a jacking member secured to the shaft, wherein the shaft is rotatable to extend the jacking member out of the bracket, and the jacking member jacks the blocking member, which is configured for holding remained products on the base.

9. The dispensing device of claim 8, wherein an extending direction of the jacking member is substantially perpendicular to the shaft.

10. The dispensing device of claim 7, wherein the bracket further comprises two pivoting pieces, the blocking member comprises two pivoting portion pivotably engaged with the two pivoting pieces, and the shaft extends through between the two pivoting pieces.

11. A dispensing device in a vending machine, comprising:
a bracket;
a base rotatably mounted to the bracket;
a shaft rotatably received in the bracket;
a tray secured to the shaft and for holding the base;
a first mounting member secured to the bracket and comprising two first sidewalls;
a second mounting member secured to the bracket and comprising two second sidewalls; and
a sleeve secured around the shaft;
wherein each first sidewall defines a first cutout, each second sidewall defines a second cutout, the first cutout and the second cutout cooperatively form an installation opening, and the shaft is rotatably received in the installation opening; a diameter of the sleeve is greater a diameter of the installation opening; and a distance between the two first sidewalls is substantially equal than a distance between the two second sidewalls, and a height of the sleeve is smaller than the distance between the two first sidewalls; and the shaft is rotatable relative to the bracket, when the shaft is rotated relative to the bracket, the tray is released and rotatable relative to the bracket, allowing a product to drop down from the base due to gravity.

12. The dispensing device of claim 11, further comprising a blocking member rotatably mounted to the bracket and a jacking member secured to the shaft, wherein the shaft is rotatable to extend the jacking member out of the bracket, and the jacking member jacks the blocking plate, which is configured for holding remained products on the base.

13. The dispensing device of claim 12, wherein an extending direction of the jacking member is substantially perpendicular to the shaft.

14. The dispensing device of claim 12, wherein the bracket defines a receiving hole, and the blocking member is received in the receiving hole; and the shaft is rotatable to extend the jacking member out of the receiving hole, to jack the blocking member out of the receiving hole.

15. The dispensing device of claim 12, wherein the bracket further comprises two pivoting pieces, the blocking member comprises two pivoting portion pivotably engaged with the two pivoting pieces, and the shaft extends through between the two pivoting pieces.

16. The dispensing device of claim 11, wherein each of the first cutout and the second cutout is semicircular.

17. The dispensing device of claim 11, wherein the first mounting member further comprises a first bottom wall connected to the first sidewalls and two first positioning pieces perpendicularly extending from the first bottom wall, the sleeve is located between the two first positioning pieces; and the second mounting member further comprises a second bottom wall connected to the second sidewalls and two second positioning pieces perpendicularly extending from the second bottom wall, and the sleeve is located between the two second positioning pieces; and the diameter of the sleeve is smaller than a distance between the two first positioning pieces and smaller than a distance between the two second positioning pieces.

18. The dispensing device of claim 17, wherein each first positioning piece is substantially perpendicular to the first sidewalls, each first sidewall is substantially coplanar with a corresponding second sidewall, and each second positioning piece is substantially perpendicular to the second sidewalls.
